(19) United States
(12) Patent Application Publication
(10) Pub. No.: US 2012/0305348 A1
(43) Pub. Date: Dec. 6, 2012

(54) SUSPENSION APPARATUS

(76) Inventors: Yohei Katayama, Yokohama-shi (JP); Takashi Nezu, Yokohama-shi (JP)

(21) Appl. No.: 13/578,351

(22) PCT Filed: Feb. 12, 2010
(86) PCT No.: PCT/JP2010/052066

§ 371 Date: Aug. 10, 2012

(51) Int. Cl. B60G 17/08; F16F 9/34; F16F 9/50

(52) U.S. Cl. 188/266.2

(57) ABSTRACT

Provided is a suspension apparatus capable of preventing excessive increase in damping force due to a sudden input from the road surface when the damping force is adjusted to a minimum value during running. A damping force control type hydraulic shock absorber (1) includes a damping force adjusting valve (25) which adjusts a damping force by a current supplied to a pressure control valve for controlling a pilot pressure. A control device (ECU) outputs a minimum control current I=0.5 A to cause the damping force control type hydraulic shock absorber (1) to generate a minimum damping force. When the minimum control current is supplied, the pressure control valve of the damping force adjusting valve (25) is always opened. Thus, an increase of the damping force caused by a rapid increase of the pilot pressure due to the sudden input from the road surface is suppressed.

### TECHNICAL FIELD

The present invention relates to a suspension apparatus.

### BACKGROUND ART

A damping force control type hydraulic shock absorber having the following structure is conventionally known (see Patent Literature 1). Specifically, a pilot chamber for applying a pilot pressure is formed in a valve body for generating a damping force, and a relief valve to be pressed by a proportional solenoid is provided for adjusting a pressure in the pilot chamber.

### CITATION LIST

### Patent Literature

Patent Literature 1: JP 06-330977 A

### SUMMARY OF INVENTION

### Technical Problem

However, in the damping force control type hydraulic shock absorber disclosed in Patent Literature 1, in a case where the pressure in the pilot chamber is equal to or lower than a force applied by the proportional solenoid, the relief valve is always closed. Accordingly, even in a condition in which a current of the proportional solenoid is lowered to generate a soft damping force, the damping force may be increased because opening of the relief valve is behind sudden input from a road surface.

The present invention has been made in view of the above, and has an object to provide a suspension apparatus capable of preventing excessive increase in damping force against the sudden input with simple structure.

### Solution to Problem

As a measure to solve the above-mentioned problem, the present invention provides a suspension apparatus, including: a damping force control type shock absorber provided between a vehicle body and an axle of a vehicle, the damping force control type shock absorber including a damping force adjusting valve; a detecting device provided to the vehicle, for outputting a signal related to a motion condition of the vehicle; and a control device for outputting a control current corresponding to a damping force target value to the damping force adjusting valve based on the signal, in which the damping force adjusting valve includes: a main valve for generating a damping force; a pilot chamber for applying a pilot pressure in a direction of closing the main valve; an inlet passage for introducing the pilot pressure into the pilot chamber; a release passage for releasing the pilot pressure in the pilot chamber; and a pressure control valve provided in the release passage, in which the pressure control valve includes: a valve seat provided in the release passage; a valve body which sits on and moves away from the valve seat; an actuator for generating a load for pressing the valve body onto the valve seat in accordance with a current; and a spring device which acts in a direction of separating the valve body from the valve seat, and wherein when the control device generates a minimum damping force during normal running, the control device outputs a minimum control current having a magnitude to always separate the valve body from the valve seat.

### Advantageous Effects of Invention

According to the suspension apparatus of the present invention, it is possible to obtain desired damping force characteristics with simple structure.

### BRIEF DESCRIPTION OF THE DRAWINGS

FIG. 1 is a block diagram of a suspension apparatus according to embodiments of the present invention.

FIG. 2 is an enlarged cross-sectional view of a damping force adjusting valve of a damping force control type hydraulic shock absorber for use in the suspension apparatus according to the embodiments of the present invention.

FIG. 3 is a plan view of a disk spring according to a first embodiment adopted in the damping force adjusting valve of FIG. 2.

FIG. 4 is a plan view of a disk spring according to a second embodiment adopted in the damping force adjusting valve of FIG. 2.

FIG. 5 is a plan view of a disk spring according to a third embodiment adopted in the damping force adjusting valve of FIG. 2.

FIG. 6 is a cross-sectional view of the damping force control type hydraulic shock absorber for use in the suspension apparatus according to the embodiments of the present invention.

FIG. 7 is an enlarged view of a portion “A” of the damping force adjusting valve of FIG. 2.

FIG. 8 is a position-load graph of a pilot valve of the suspension apparatus according to the embodiments of the present invention.

### REFERENCE SIGNS LIST

1 damping force control type hydraulic shock absorber (damping force control type shock absorber), 2 cylinder, 3 outer cylinder, 5 piston, 6 piston rod, 25 damping force adjusting valve, 27 main valve, 28 pilot valve, 32 disk valve, 35 solenoid case, 38 coil (solenoid), 55 first communication member, 64 spring element, 70a to 70c disk spring, 71 coil spring, 86 second communication member, 91 third communication member, 97 pilot chamber

### DESCRIPTION OF EMBODIMENTS

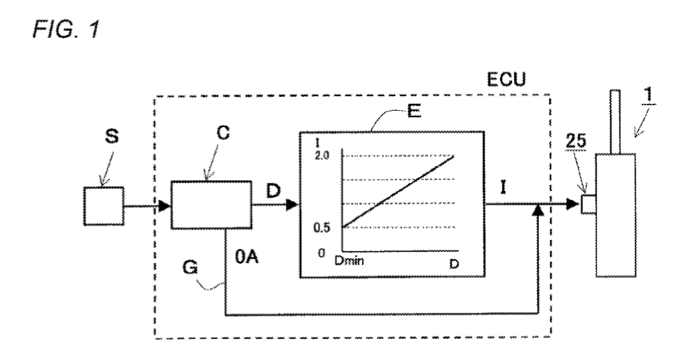

In the following, embodiments for carrying out the present invention are described in detail with reference to FIGS. 1 to 8.

First, FIG. 1 illustrates a block diagram of a control circuit for only one wheel of a suspension apparatus according to the present invention.

One or a plurality of sensors S are provided to a vehicle, and serve as a detecting device for outputting a signal related to a vehicle motion condition. Examples of the sensors S include: sensors for detecting a motion of the vehicle directly, such as a sprung vertical acceleration sensor for detecting a vertical acceleration of a vehicle body, a longitudinal acceleration sensor for detecting a longitudinal acceleration of the vehicle body, a lateral acceleration sensor for detecting a lateral acceleration of the vehicle body, an unsprung vertical acceleration sensor for detecting a vertical acceleration of a wheel, a vehicle height sensor for detecting a vehicle height, and a vehicle speed sensor for detecting a vehicle speed; sensors for measuring an operation amount of a driver causing a future motion of the vehicle, such as a steering sensor for detecting an angle and an angular velocity of a steering wheel, a brake sensor, and an accelerator sensor; and sensors based on information from a navigation and the like.

A signal detected by the one or the plurality of sensors S among the exemplified sensors is input to a damping force computing device C which is provided in an electronic control unit (ECU) as a control device, for computing a target damping force value. The damping force computing device C stores a control program for vibrations of the vehicle body based on a control theory such as sky-hook control or H∞ control. The damping force computing device C processes the signal from the sensors S, and computes and outputs a target damping force value D for each wheel. The target damping force value D is output at every control cycle, for example, at every 1/100 seconds, and is input to a current conversion circuit E. Note that, in the present invention, any control theory and any control program may be used in the damping force computing device C.

The current conversion circuit E stores a map based on a relation between a current and a damping force to be generated in a damping force control type hydraulic shock absorber 1, and outputs a current I corresponding to the target damping force value D to a damping force adjusting valve 25 of the damping force control type hydraulic shock absorber 1 provided to each wheel, which is described later. According to the embodiments of the present invention, a current of 0.5 A is output in a case where a minimum damping force is required, whereas a current of 2.0 A is output in a case where a maximum damping force is required. The values of the currents are not limited thereto, and are determined depending on a specification of the damping force adjusting valve 25. Further, the above-mentioned map may be a form of a correspondence table between the value D and the current I, or a form of an arithmetic expression. Still further, the current I to be output may be a direct current or a pulse-width modulation (PWM) current. In a case where the PWM current is used, a current in the following description refers to a mean current.

The damping force computing device C stores current cut-off control for cutting off a control current, for example, when some control error occurs or when the vehicle is stopped for a predetermined period of time or longer. When it is judged in the current cut-off control that current cut-off is required, the target damping force value D is not output, but a signal indicating a current of 0 A is output from a line G. As a result, no current is supplied to the damping force adjusting valve 25.

Note that, the current is 0 A in the current cut-off control, but a current extremely low enough to practically prevent movement of a pilot valve 28 described later may be caused to flow.

Next, description is made of the damping force control type hydraulic shock absorber 1 as a damping force control type shock absorber according to the embodiments of the present invention, which is provided between the vehicle body and an axle at each of front, rear, right, and left four positions of the vehicle.

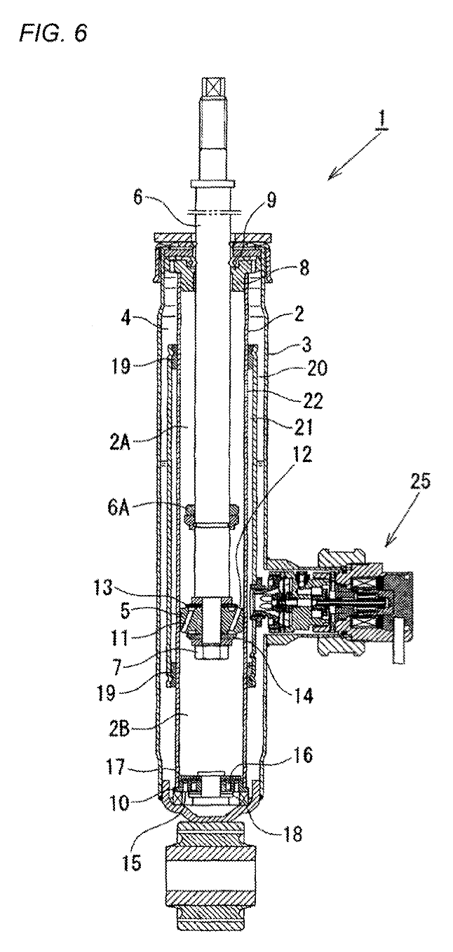

As illustrated in FIG. 6, the damping force control type hydraulic shock absorber 1 according to the embodiments of the present invention has double-cylinder structure in which an outer cylinder 3 is provided outside a cylinder 2 filled with a hydraulic fluid. Between the cylinder 2 and the outer cylinder 3, there is formed a reservoir 4 containing therein the hydraulic fluid and gas such as the air and nitrogen.

A piston 5 is slidably fitted within the cylinder 2, and the piston 5 divides an inside of the cylinder 2 into two chambers, an upper cylinder chamber 2A (chamber on one end side) and a lower cylinder chamber 2B (chamber on the other end side). One end of a piston rod 6 is coupled to the piston 5 by a nut 7. The other end side of the piston rod 6 passes through the upper cylinder chamber 2A and is inserted through a rod guide 8 and an oil seal 9, which are fitted to an upper end portion of the cylinder 2 and an upper end portion of the outer cylinder 3 respectively, and extends to the outside of the cylinder 2. A base valve 10 for partitioning between the lower cylinder chamber 2B and the reservoir 4 is provided at a lower end portion of the cylinder 2.

Note that, a rebound stopper 6A is provided onto a middle portion of the piston rod 6.

A compression-stroke piston hydraulic fluid passage 11 and an extension-stroke piston hydraulic fluid passage 12 are formed in the piston 5 so as to provide communication between the upper cylinder chamber 2A and the lower cylinder chamber 2B. Further, a check valve 13 is provided to the compression-stroke piston hydraulic fluid passage 11. The check valve 13 allows flow of the hydraulic fluid only from the lower cylinder chamber 2B into the upper cylinder chamber 2A, and hardly generates a damping force. Further, a disk valve 14 is provided to the extension-stroke piston hydraulic fluid passage 12. The disk valve 14 is opened when a pressure of the hydraulic fluid in the upper cylinder chamber 2A reaches a predetermined pressure (for example, pressure generated when a piston speed is equal to or higher than 1.5 m/s), and the disk valve 14 relieves the pressure toward the lower cylinder chamber 2B. Note that, the check valve 13 may generate the damping force, and the disk valve 14 does not have to be provided. The check valve 13 and the disk valve 14 are designed as needed depending on desired characteristics.

An extension-stroke base hydraulic fluid passage 15 and a compression-stroke base hydraulic fluid passage 16 are formed in the base valve 10 so as to provide communication between the lower cylinder chamber 2B and the reservoir 4. Further, a check valve 17 is provided to the extension-stroke base hydraulic fluid passage 15. The check valve 17 allows flow of the hydraulic fluid only from the reservoir 4 into the lower cylinder chamber 2B, and hardly generates the damping force. Further, a disk valve 18 is provided to the compression-stroke base hydraulic fluid passage 16. The disk valve 18 is opened when a pressure of the hydraulic fluid in the lower cylinder chamber 2B reaches a predetermined pressure (for example, pressure generated when the piston speed is equal to or higher than 1.5 m/s), and the disk valve 18 relieves the pressure toward the reservoir 4. Note that, the check valve 17 may generate the damping force, and the disk valve 18 does not have to be provided. The check valve 17 and the disk valve 18 are designed as needed depending on desired characteristics.

A separator tube 20 is outwardly fitted onto both upper and lower end portions of the cylinder 2 through the intermediation of sealing members 19. An annular hydraulic fluid passage 21 is formed between the cylinder 2 and the separator tube 20. The annular hydraulic fluid passage 21 is communicated to the upper cylinder chamber 2A through a hydraulic fluid passage 22 which is formed in a side wall of the cylinder 2 situated near the upper end portion thereof. An opening 23 having a small diameter is formed in a side wall of the separator tube 20, and an opening 24 having a large diameter is formed in a side wall of the outer cylinder 3 substantially concentrically with the opening 23. The damping force adjusting valve 25 is fitted in the opening 23 of the separator tube 20 and the opening 24 of the outer cylinder 3.

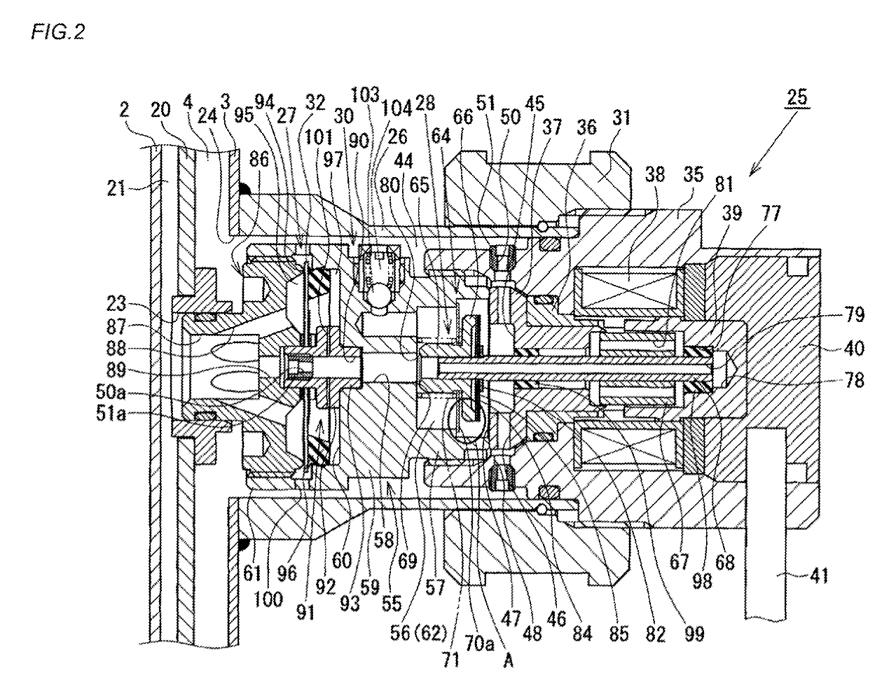

The damping force adjusting valve 25 is described with reference to FIG. 2. One end portion of a cylindrical case 26 is fixed by welding to the opening 24 formed in the outer cylinder 3. A valve unit 30 integrally including a main valve 27 and the pilot valve 28 is inserted in the case 26.

The valve unit 30 includes a solenoid case 35 fixed to the case 26 by a nut 31. The solenoid case 35 is formed into a cylindrical shape. The solenoid case 35 accommodates therein a first stepped cylindrical member 36 abutting on an inner peripheral surface of the solenoid case 35, and a second stepped cylindrical member 37 abutting on an inner peripheral surface of the first stepped cylindrical member 36 and protruding from one end of the first stepped cylindrical member 36.

Further, a coil 38 (solenoid) is accommodated in the solenoid case 35 on the first stepped cylindrical member 36 side. A core 40 is fitted to the coil 38 through the intermediation of a bottomed cylindrical guide member 39, and the core 40 is also fixed to the solenoid case 35 by caulking. In this manner, the coil 38 is fixed to the solenoid case 35. A lead wire 41 for energizing is connected to the coil 38 so as to extend to the outside.

An annular chamber 44 is formed between one end portion of the solenoid case 35 (on a side opposite to the core 40) and the case 26, and the annular chamber 44 is communicated to the opening 24 formed in the outer cylinder 3 and also to the reservoir 4. Further, a recessed portion 45 is formed in a large-diameter portion of the second stepped cylindrical member 37, and a plurality of radial hydraulic fluid passages 46 extending radially are formed so as to face the recessed portion 45. An outer periphery of the recessed portion 45 of the second stepped cylindrical member 37 functions as a stepped portion 47 on which a large-diameter portion 66 of the pilot valve 28 is brought into abutment at the time of non-energization. In addition, in a peripheral wall of the one end portion of the solenoid case 35, hydraulic fluid passages 48 extending radially are formed so as to be opposed to the respective radial hydraulic fluid passages 46 formed in the second stepped cylindrical member 37. An adjusting screw 51 including a hydraulic fluid passage 50 is screwed into each of the hydraulic fluid passages 48 on the annular chamber 44 side.

A first communication member 55 is fitted to one opening end of the solenoid case 35. That is, the first communication member 55 includes: a small-diameter portion 57 in which a first recessed portion 56 is formed; a mid-diameter portion 59 in which an axial hydraulic fluid passage 58 communicated to the first recessed portion 56 is formed; and a large-diameter portion 61 in which a second recessed portion 60 communicated to the axial hydraulic fluid passage 58 is formed. Further, the small-diameter portion 57 of the first communication member 55 is screwed into an inner peripheral surface of the one opening end of the solenoid case 35, and the inside of the first recessed portion 56 functions as a valve chamber 62.

The pilot valve 28 (valve body) is accommodated in the valve chamber 62 so as to be movable in an axial direction. The pilot valve 28 includes a small-diameter portion 65 and the large-diameter portion 66, and has a substantially convex shape. A tip of a hollow rod 68 fixed to a plunger 67 is inserted into the pilot valve 28 in the axial direction. At a tip of the small-diameter portion 65 of the pilot valve 28, an annular seat portion 80 is formed so as to sit on and move away from a seat surface 69 (valve seat) which is situated at the bottom of the first recessed portion 56 of the first communication member 55 and in the vicinity of the opening of the axial hydraulic fluid passage 58. Further, between the large-diameter portion 66 of the pilot valve 28 and the bottom of the first recessed portion 56, a spring element 64 serving as a spring device having nonlinear spring characteristics is arranged. Specifically, the spring element 64 is formed by combining a disk spring 70a (having a spring constant K1) and a coil spring 71 (having a spring constant K2), and the disk spring 70a and the coil spring 71 are arranged in the stated order from the large-diameter portion 66 side. Here, it is desired that the spring constant K1 be set to be larger than the spring constant K2, but it is only necessary that a spring constant K1+K2 be larger than the spring constant K2.

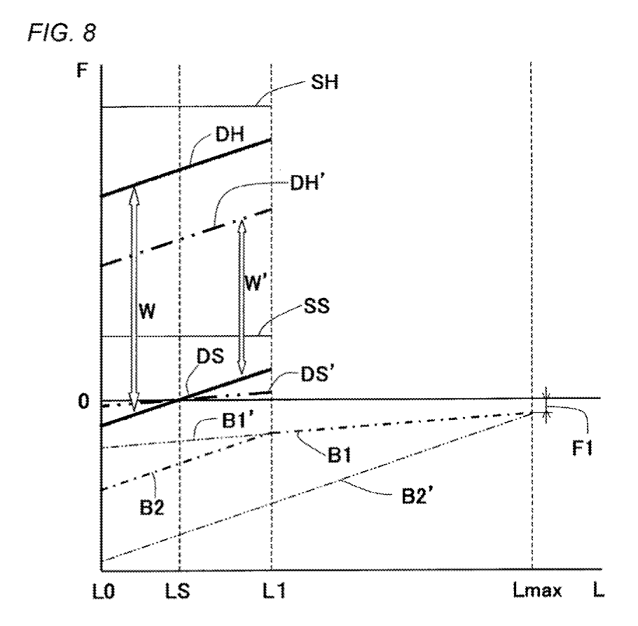

As illustrated in FIGS. 2, 3, and 7, an outer peripheral edge of the disk spring 70a abuts on a stepped portion 73 of the inner peripheral surface of the first recessed portion 56. Note that, it is desired that the following distance be equal to or larger than a maximum displacement L1 illustrated in FIG. 8: the distance from the seat surface 69 (valve seat) to the annular seat portion 80 formed at the tip of the pilot valve 28 in a state in which the disk spring 70a does not deform. The distance is set as appropriate.

Here, control during normal running includes control performed in a stop condition, and refers to a normal control condition in which the target damping force value D is output from the controller C in accordance with signals output from the various sensors S. In this case, a current of from 0.5 A to 2.0 A is output. Note that, besides the normal control condition, there are non-energized conditions such as a condition in which an ignition key of the vehicle is turned OFF, a condition in which a current does not flow physically due to breaking of wire or the like, and a condition in which a current is set to 0 A through the above-mentioned current cut-off control performed during a longtime stop or a failure.

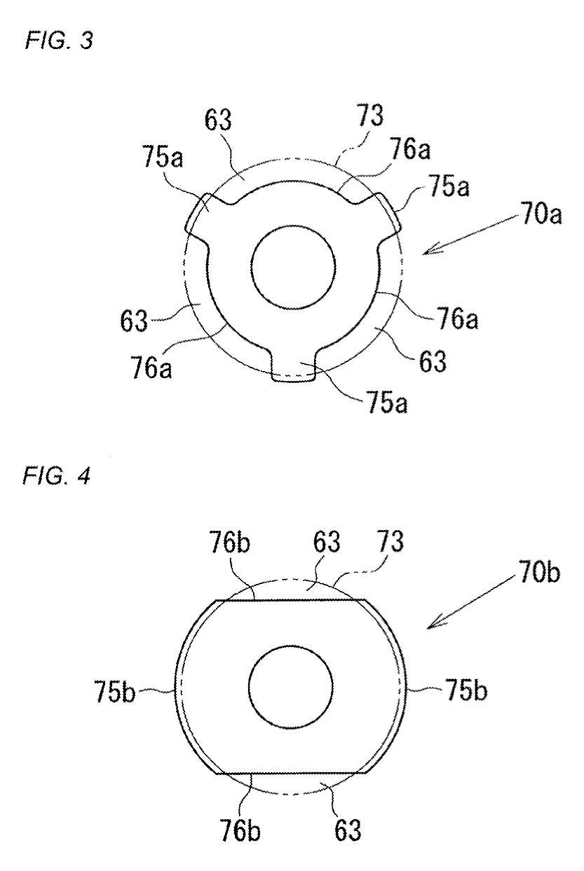

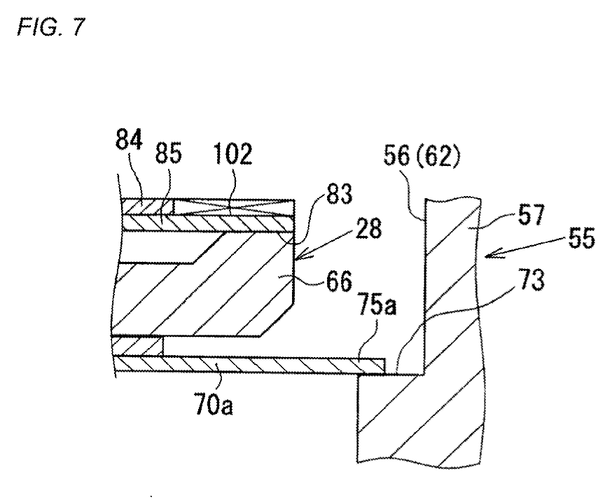

As illustrated in FIG. 3, the disk spring 70a according to a first embodiment includes three large-diameter curved portions 75a and three small-diameter curved portions 76a arranged alternately in a peripheral direction. The large-diameter curved portions 75a each have a diameter slightly larger than an inner diameter of the stepped portion 73 provided on the inner peripheral surface of the first recessed portion 56, and the small-diameter curved portions 76a each have a diameter slightly smaller than the inner diameter of the stepped portion 73. The small-diameter curved portions 76a are each shaped to have a peripheral length which is about three times larger than a peripheral length of the large-diameter curved portion 75a. As illustrated in FIG. 7, the disk spring 70a is arranged to be slightly curved entirely so that each of the large-diameter curved portions 75a of the disk spring 70a is brought into abutment on the stepped portion 73. In a gap between the stepped portion 73 and each of the small-diameter curved portions 76a, a hydraulic fluid passage 63 for allowing flow of the hydraulic fluid is formed.

Further, as illustrated in FIG. 4, a disk spring 70b according to a second embodiment is shaped to include: a pair of large-diameter curved portions 75b, 75b each having an outer diameter slightly larger than the inner diameter of the stepped portion 73 provided on the inner peripheral surface of the first recessed portion 56; and a pair of straight portions 76b, 76b extending in parallel to each other at a spacing smaller than a diameter of the large-diameter curved portion 75b. Similarly to the first embodiment, the disk spring 70b is arranged to be slightly curved entirely so that each of the large-diameter curved portions 75b of the disk spring 70b is brought into abutment on the stepped portion 73. In a gap between the stepped portion 73 and each of the straight portions 76b, the hydraulic fluid passage 63 for allowing flow of the hydraulic fluid is formed.

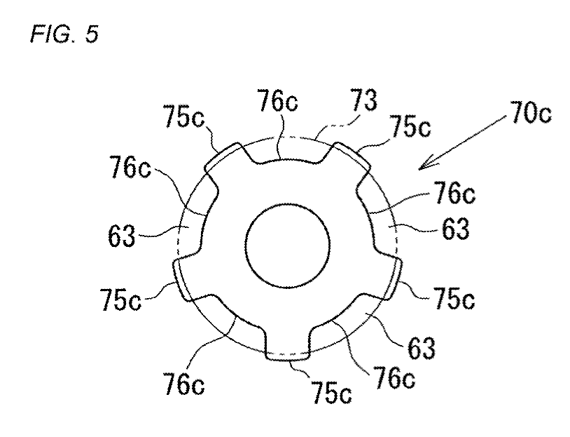

Still further, as illustrated in FIG. 5, a disk spring 70c according to a third embodiment includes five large-diameter curved portions 75c and five small-diameter curved portions 76c arranged alternately in the peripheral direction. The large-diameter curved portions 75c each have a diameter slightly larger than the inner diameter of the stepped portion 73 provided on the inner peripheral surface of the first recessed portion 56, and the small-diameter curved portions 76c each have a diameter slightly smaller than the inner diameter of the stepped portion 73. The small-diameter curved portions 76c are each shaped to have a peripheral length which is about 1.5 times larger than a peripheral length of the large-diameter curved portion 75c. Similarly to the first and second embodiments, the disk spring 70c is arranged to be slightly curved entirely so that each of the large-diameter curved portions 75c of the disk spring 70c is brought into abutment on the stepped portion 73. In a gap between the stepped portion 73 and each of the small-diameter curved portions 76c, the hydraulic fluid passage 63 for allowing flow of the hydraulic fluid is formed.

The rod 68 is fixed to the plunger 67 so as to pass through the plunger 67. The rod 68 is slidably inserted into the second stepped cylindrical member 37 and a guide hole 77 formed in the bottom of the bottomed cylindrical guide member 39 for guiding one end portion of the plunger 67, and the tip of the rod 68 is inserted in the axial direction into the pilot valve 28 accommodated in the first recessed portion 56 of the first communication member 55. Note that, a sealing member 98 seals between the rod 68 and an end part of the guide hole 77, and a sealing member 99 seals between the rod 68 and an inner part of the second stepped cylindrical member 37 adjacent to the recessed portion 45. A valve body back-pressure chamber 78 is formed in an opening part of the bottom end of the guide hole 77. The valve body back-pressure chamber 78 is communicated to the inner side of the annular seat portion 80 of the pilot valve 28 through a communication passage 79 formed in the hollow rod 68.

A snap ring 82 is fixed to a stepped portion formed on the other end side of the rod 68. Between the snap ring 82 and an abutment portion 83 (see FIG. 7) protruding in an annular manner from an outer peripheral portion of one end surface of the large-diameter portion 66 of the pilot valve 28, an annular seat member 84 (see also FIG. 7) and a leaf spring 85 (see also FIG. 7) are interposed. An outer peripheral portion of the seat member 84 and an outer peripheral portion of the leaf spring 85 abut on the abutment portion 83 of the large-diameter portion 66 of the pilot valve 28, whereas inner peripheral portions thereof abut on the snap ring 82.

With this structure, when the pilot valve 28 is closed, that is, in a state in which the seat portion 80 of the pilot valve 28 sits on the seat surface 69 which is situated at the bottom of the first recessed portion 56 of the first communication member 55 and in the vicinity of the opening of the axial hydraulic fluid passage 58, the valve body back-pressure chamber 78 is communicated to the axial hydraulic fluid passage 58 through the communication passage 79 of the rod 68. Accordingly, a pressure-receiving area of the pilot valve 28 with respect to the axial hydraulic fluid passage 58 is obtained by subtracting a cross-sectional area of the rod 68 from an area of the inner side of the seat portion 80, and thus the pressure-receiving area of the pilot valve 28 with respect to the axial hydraulic fluid passage 58 can be adjusted not only by a diameter of the seat portion 80 but also by a diameter of the rod 68. Therefore, it is possible to increase a degree of freedom in setting valve opening characteristics of the pilot valve 28, thus a degree of freedom in setting damping force characteristics of the damping force adjusting valve 25. Further, the plunger 67 includes a throttle passage 81 formed therein, for providing communication between chambers formed at both ends thereof, and thus a moderate damping force is applied to movement of the plunger 67.

One end of a second communication member 86 is screwed into and integrally coupled to the second recessed portion 60 of the large-diameter portion 61 of the first communication member 55. On the other hand, the other end of the second communication member 86 is fitted to the opening 23 of the separator tube 20, and a main hydraulic fluid passage 87 formed in the second communication member 86 so as to extend axially is communicated to the annular hydraulic fluid passage 21 in the separator tube 20.

The second communication member 86 includes: a plurality of obliquely-branched hydraulic fluid passages 88 formed at intervals in the peripheral direction so as to extend obliquely from the inner peripheral surface of the main hydraulic fluid passage 87; and an axially-branched hydraulic fluid passage 89 extending axially and continuously with the main hydraulic fluid passage 87. Further, onto a radial center of one end surface of the second communication member 86 and a radial center of the bottom of the second recessed portion 60 of the first communication member 55, a third communication member 91 including a main communication passage 90 formed therein is fitted. The main communication passage 90 communicates the axially-branched hydraulic fluid passage 89 of the second communication member 86 and the axial hydraulic fluid passage 58 of the first communication member 55 to each other. The third communication member 91 is formed into a cross shape in cross-section to include a radially protruding portion 92 and an axially protruding portion 93. An adjusting screw 51a including a hydraulic fluid passage 50a formed therein is screwed into the main communication passage 90 of the third communication member 91. Note that, in the radially protruding portion 92 of the third communication member 91, a radial hydraulic fluid passage 101 for providing communication between the main communication passage 90 and a pilot chamber 97 is formed.

Further, a leading opening end of each of the obliquely-branched hydraulic fluid passages 88 extending from the inner peripheral surface of the main hydraulic fluid passage 87 of the second communication member 86 faces an annular chamber 95 formed by protruding a valve seat 94 on an outer peripheral portion of the one end surface of the second communication member 86. Inner peripheral portions of a plurality of laminated disk valves 32 of the main valve 27 are clamped between the one end surface of the second communication member 86 and the radially protruding portion 92 of the third communication member 91 and around the axially protruding portion 93, whereas outer peripheral portions of the disk valves 32 sit on the annular valve seat 94.

In addition, an annular sealing member 96 is fixed onto back surfaces of the disk valves 32, and the sealing member 96 is fluid-tightly and slidably fitted onto a small-diameter inner peripheral surface of the second recessed portion 60 of the first communication member 55. Thus, the pilot chamber 97 is formed in the second recessed portion 60 of the first communication member 55.

Note that, in a peripheral wall of the second recessed portion 60 of the first communication member 55 and at positions along a line extending radially from outer peripheral edges of the disk valves 32, there are formed opening portions 100 for providing communication between the annular chamber 95 and the annular chamber 44 formed between the case 26 and the first communication member 55.

Further, the disk valves 32 receive a pressure of the hydraulic fluid from the obliquely-branched hydraulic fluid passages 88 formed in the second communication member 86, and thus are deformed (opened) to move away from the valve seat 94. As a result, the annular chamber 95 of the second communication member 86 is communicated to the annular chamber 44. In this manner, the disk valves 32 and the pilot chamber 97 form a pilot type (back-pressure type) damping valve, and an internal pressure in the pilot chamber 97 is applied in a direction of closing the disk valves 32.

Further, the coil 38, the plunger 67, the second stepped cylindrical member 37, and the like form an actuator for generating a load to press the pilot valve 28 (valve body) onto the seat surface 69 (valve seat).

In addition, the axial hydraulic fluid passage 58, the first recessed portion 56, the stepped portion 47, the hydraulic fluid passage 50, the annular chamber 44, and the like form a release passage for releasing the pressure in the pilot chamber 97 toward the reservoir 4.

Further, the seat surface 69 (valve seat) is provided on the midway of the release passage. A pressure control valve is formed of the pilot valve 28 (valve body) that sits on and moves away from the seat surface 69 (valve seat), and the actuator for pressing the pilot valve 28 (valve body). In a side surface of the first communication member 55, there is formed a relief passage 104 for providing communication between the valve chamber 62 and the annular chamber 44. In the relief passage 104, there is provided a relief valve 103 including a ball and a coil spring, for allowing flow of the hydraulic fluid only from the valve chamber 62 into the annular chamber 44. The relief valve 103 determines the damping force characteristics which are generated at the disk valves 32 when the coil 38 is disconnected to be out of control.

Note that, the form of the relief valve 103 is not limited to a ball valve. As long as the relief valve 103 generates a resistance force against the flow of the hydraulic fluid from the valve chamber 62 into the annular chamber 44, a disk valve or the like may be adopted.

Next, description is made of actions of the damping force control type hydraulic shock absorber 1 according to the embodiments of the present invention configured as described above.

The damping force control type hydraulic shock absorber 1 is provided to the suspension apparatus of a vehicle such as an automobile in the following manner. The cylinder 2 side is coupled to an unsprung side of the vehicle, whereas the piston rod 6 side is coupled to a sprung side of the vehicle. Further, the lead wire 41 of the coil 38 is connected to the ECU.

During an extension stroke of the piston rod 6, the check valve 13 of the piston 5 is closed in accordance with movement of the piston 5 within the cylinder 2. Before the disk valve 14 is opened, the hydraulic fluid in the upper cylinder chamber 2A is pressurized, to thereby flow through the hydraulic fluid passage 22 and the annular hydraulic fluid passage 21 and then flow from the opening 23 of the separator tube 20 into the main hydraulic fluid passage 87 of the second communication member 86 of the damping force adjusting valve 25.

Further, before the disk valves 32 of the damping force adjusting valve 25 are opened, the hydraulic fluid flows through the axially-branched hydraulic fluid passage 89 of the second communication member 86, the hydraulic fluid passage 50a of the adjusting screw 51a provided in the main communication passage 90 of the third communication member 91, and the axial hydraulic fluid passage 58 of the first communication member 55, and then, the hydraulic fluid opens the pilot valve 28 to flow into the valve chamber 62. The hydraulic fluid further flows through each of the radial hydraulic fluid passages 46 of the second stepped cylindrical member 37, the hydraulic fluid passage 50 of the adjusting screw 51 provided in each of the hydraulic fluid passages 48 of the solenoid case 35, and then flows from the annular chamber 44 into the reservoir 4. Further, a part of the hydraulic fluid, which flows in the main communication passage 90 of the third communication member 91, flows through the radial hydraulic fluid passage 101 of the third communication member 91 into the pilot chamber 97. Here, the hydraulic fluid passage 50a of the adjusting screw 51a forms an inlet passage according to the present invention. Further, when the pressure in the annular chamber 95 of the second communication member 86 reaches a pressure for opening the disk valves 32, the disk valves 32 are opened, and the hydraulic fluid flows from each of the opening portions 100 of the second communication member 55 into the reservoir chamber 4 through the annular chamber 44.

At this time, the check valve 17 of the base valve 10 is opened to flow the hydraulic fluid in a volume corresponding to movement of the piston 5 from the reservoir 4 into the lower cylinder chamber 2B. Note that, when the pressure in the upper cylinder chamber 2A reaches a pressure for opening the disk valve 14 of the piston 5, the disk valve 14 is opened to relieve the pressure in the upper cylinder chamber 2A toward the lower cylinder chamber 2B. This prevents excessive increase in pressure in the upper cylinder chamber 2A.

During a compression stroke of the piston rod 6, the check valve 13 of the piston 5 is opened in accordance with movement of the piston 5 within the cylinder 2, and the check valve 17 of the extension-stroke base hydraulic fluid passage 15 of the base valve 10 is closed. Before the disk valve 18 is opened, the hydraulic fluid in the lower piston chamber 2B flows into the upper cylinder chamber 2A, and the hydraulic fluid in a volume corresponding to entry of the piston rod 6 into the cylinder 2 flows from the upper cylinder chamber 2A into the reservoir 4 through the damping force adjusting valve 25 while flowing through the same route as the above-mentioned route during the extension stroke. Note that, when the pressure in the lower cylinder chamber 2B reaches a pressure for opening the disk valve 18 of the base valve 10, the disk valve 18 is opened to relieve the pressure in the lower cylinder chamber 2B toward the reservoir 4. This prevents excessive increase in pressure in the lower cylinder chamber 2B.

In this manner, during both the extension and compression strokes of the piston rod 6, before the disk valves 32 are opened (in a micro-low speed range in which the piston speed is equal to or lower than about 0.1 m/S), the pilot valve 28 generates the damping force. After the disk valves 32 are opened (in a normal speed range of the piston speed), the damping force is generated depending on a degree of opening of the disk valves 32. Further, a current applied to the coil 38 changes a thrust force of the plunger, to thereby adjust the pressure for opening the pilot valve 28. Thus, regardless of the piston speed, the damping force can be controlled directly. (However, in fact, even when the same current is applied, the damping force slightly increases depending on the piston speed.) At this time, the internal pressure in the pilot chamber 97 is adjusted by the pressure for opening the pilot valve 28, and hence the pressure for opening the disk valves 32 can be adjusted at the same time. This can enlarge a range of adjusting the damping force characteristics.

Further, in the normal control condition in which the pressure for opening the pilot valve 28 is adjusted by the current applied to the coil 38, a resultant force acts, which is generated by an urging force of the disk spring 70a (70b, 70c) having the spring constant K1 and an urging force of the coil spring 71 having the spring constant K2 of the spring element 64. Further, the thrust force generated by the coil 38, and the resultant force of the urging forces of the coil spring 71 and the disk spring 70a (70b, 70c) “the resultant force=the thrust force generated by the coil 38−(the urging force of the disk spring 70a+the urging force of the coil spring 71)” act as the pressure for opening the pilot valve 28.

Meanwhile, in the non-energized condition in which the current cut-off control is being performed, the thrust force in a direction of closing the pilot valve 28 is lost, and the disk spring 70a (70b, 70c) is disengaged from the stepped portion 73 formed in the first recessed portion 56 of the first communication member 55, and thus loses its urging force. The pilot valve 28 is retreated by the urging force of the coil spring 71 having the spring constant K2, and thus abuts on the stepped portion 47 of the second stepped cylindrical member 37. As a result, the valve chamber 62 is communicated to each of the radial hydraulic fluid passages 46 of the second stepped cylindrical member 37 and each of the hydraulic fluid passages 48 of the solenoid case 35 via an orifice 102 (see FIG. 7). Note that, when the pressure in the valve chamber 62 increases due to increase in piston speed and the like to reach the pressure for opening the relief valve 103, the relief valve 103 is opened to relieve the pressure in the valve chamber 62 toward the annular chamber 44.

It is desired that the damping force generated when the relief valve 103 is opened be nearly equal to a damping force that is set in a case where a passive hydraulic shock absorber is used in the vehicle provided with the suspension apparatus according to the present invention. This damping force is higher than a damping force generated when a minimum control current is applied.

Next, description is made of setting the spring element 64 and a thrust force of the actuator (thrust force generated by the coil 38) with reference to FIG. 8.

Regarding the damping force control type hydraulic shock absorber 1 according to the embodiments of the present invention, FIG. 8 shows a graph of a relation between each load F and a position L of the pilot valve 28. Note that, in FIG. 8, a Y-axis shows a direction in which the pilot valve 28 (valve body) is pressed onto the seat surface 69 (valve seat) as a positive value, and shows a direction in which the pilot valve 28 is separated from the seat surface 69 as a negative value. In FIG. 8, a dashed-dotted lineshows a spring force exerted by the spring element 64. In a range between a valve closed position L0 of the pilot valve 28 and a maximum assumed valve opening position L1 of the pilot valve 28 in the normal control condition, a resultant force B2 of the disk spring 70a (70b, 70c) and the coil spring 71 acts on the pilot valve 28 as an urging force, and hence the spring constant (angle of slope) is large, the disk spring 70a (70b, 70c) and the coil spring 71 being arranged in parallel along the direction of opening the pilot valve 28. When the pilot valve 28 is displaced to a position far from the position L1, a force B1 exerted only by the coil spring 71 acts, and hence the spring constant (angle of slope) is small. Here, design is made so that the coil spring 71 exerts a force by an amount F1 even at a maximum possible displacement position Lmax of the pilot valve 28, and hence in the non-energized conditions, the pilot valve 28 is pressed at the maximum possible displacement position Lmax.

Next, a thin solid line SS shows a thrust force generated by the coil 38 when supplying a current of 0.5 A as the minimum control current that is caused to flow through the coil 38 in order to obtain the minimum damping force (soft characteristics) in the normal control condition. Further, a thin solid line SH shows a thrust force generated by the coil 38 when supplying a current of 2.0 A (maximum control current) to the coil 38 in order to obtain the maximum damping force (hard characteristics) in the normal control condition.

A thick solid line DS shows a load on the pilot valve 28 when supplying the current of 0.5 A to the coil 38, and the load on the pilot valve 28 is obtained by adding up the thrust force generated by the coil 38 and the spring force B2 exerted by the spring element 64. Here, in a normal pressure control valve, when the pressure in the axial hydraulic fluid passage 58 is low (the piston speed is low), the pilot valve 28 sits on the seat surface 69 (valve seat), and hence a value of the load DS at the position L0 in a soft condition satisfies DS>0. However, in the present invention, DS<0 is satisfied. Accordingly, the pilot valve 28 is situated at a position LS at which the thrust force generated by the coil 38 and the spring force B2 exerted by the spring element 64 are balanced.

As a current supplied to the coil 38 is increased, the pilot valve 28 gradually moves close to the seat surface 69 (valve seat), and then sits on the seat surface 69. When the current is further increased, the pressure for opening the pilot valve 28 increases to reach a maximum load DH.

When the pressure in the axial hydraulic fluid passage 58 increases under the above-mentioned respective current conditions, the pilot valve 28 moves away from the seat surface 69 (valve seat). Then, when a valve opening area of the pilot valve 28 approximates a passage area of the hydraulic fluid passage 50a, the pressure in the axial hydraulic fluid passage 58 does not increase so that the pilot valve 28 is not displaced any more.

Here, if, without the disk spring 70a (70b, 70c), only the coil spring 71 is employed, and an initial position of the pilot valve 28 in the soft condition is set to the position LS, a load in the soft condition is shown by a line DS'. In this case, a current in the soft condition is lower than 0.5 A. However, when the load in the soft condition has a small angle of slope as shown by the line DS', the position of the pilot valve 28 is significantly changed relative to variations in the thrust force generated by the coil 38 and spring loads exerted by the coil spring 71 and the disk spring 70a, and hence the damping force significantly varies from product to product. As a result, there is a problem in that detailed adjustment is required for each product, thereby increasing man-hours for management for supplying stable products. However, when the angle of slope of the load DS is increased, it is possible to not only stabilize the balanced position of the pilot valve 28 in the soft condition, but also stably obtain desired damping force characteristics in the soft condition. Further, it is possible to reduce a variation in spring constant and a variation in load during assembly. As a result, highly accurate damping force characteristics can be obtained. In addition, the urging force of the disk spring 70a (70b, 70c) having a large spring constant acts, and hence chattering vibrations of the pilot valve 28 can be reduced.

Meanwhile, in a case where the spring constant is increased in the entire range between the position L0 and the position Lmax as shown by a line B2′, the same slope characteristics as those in the above-mentioned embodiments can be obtained as the load DS in the soft condition. The minimum control current in the soft condition at this time is higher than 0.5 A. Further, when the same coil as the coil 38 according to the above-mentioned embodiments is used, the maximum load, which is generated when causing the maximum control current of 2.0 A to flow, draws a line DH′ and is lower than the load DH in the hard condition in the above-mentioned embodiments. Accordingly, a variable width W′ of the damping force is narrower than a variable width W of the damping force according to the above-mentioned embodiments, which reduces a performance in terms of the variable width of the damping force. Further, the current in the soft condition and the like is increased, and hence power consumption is increased.

As described above, as in the above-mentioned embodiments, the spring element 64 is set to have a large spring constant near the position L0, and to have a small spring constant at the maximum valve opening position L1 of the pilot valve 28 or the position far from the position L1. Thus, it is possible to reduce the power consumption, and to reduce an individual difference of damping characteristics in each product with respect to variations of the spring element 64, the solenoid, and the like.

Further, enlargement of the variable width of the damping force enables increase in control performance exerted by a semi-active suspension.

Thus, in the damping force control type hydraulic shock absorber 1 according to the embodiments of the present invention, in particular, between the large-diameter portion 66 of the pilot valve 28 and the bottom of the first recessed portion 56 of the first communication member 55, the disk spring 70a (70b, 70c) having the spring constant K1 and the coil spring 71 having the spring constant K2 are arranged as the spring element 64. Accordingly, it is possible to obtain stable damping force characteristics in a soft damping force condition, and to obtain a desired variable width of the damping force.

Further, in the above-mentioned embodiments, the disk spring having a larger spring constant than that of the coil spring acts at the position at which the valve body sits on the valve seat. Here, the disk spring moves horizontally, and hence has an advantage of being capable of sitting on the seat portion in a horizontal posture but has a disadvantage of having difficulty in coping with a long stroke. In contrast, the coil spring has an advantage of being capable of affording the long stroke but has a disadvantage of having difficulty in sitting in a horizontal posture due to applied unbalanced load. In the damping force control type hydraulic shock absorber 1 according to the embodiments of the present invention, in the light of the advantages and the disadvantages, the disk spring having a larger spring constant than that of the coil spring is used, and the disk spring acts at the position at which the valve body sits on the valve seat. Accordingly, at the moment at which the valve body sits on the valve seat, an influence of the disk spring is increased, to thereby enable the valve body to sit on the valve seat in a horizontal posture. In contrast, when the pilot valve 28 abuts on the stepped portion 47, the non-energized condition is established. In this condition, even when a certain gap is formed between the pilot valve 28 and the stepped portion 47 due to the unbalanced load on the coil spring so that the damping force characteristics are somewhat influenced, this does not cause too much trouble. Accordingly, the urging force of the disk spring 70a acts near the position L0, whereas the urging force of the coil spring 71 acts in the non-energized condition. Thus, each of the springs can exert its function.

A combination between the disk spring 70a and the coil spring 71 makes it possible to obtain effects even at the minimum control current, or even when using a suspension apparatus which performs energization control so as to bring the valve body into contact with the valve seat.

Note that, in the damping force control type hydraulic shock absorber 1 according to the embodiments of the present invention, the spring element 64 having the nonlinear spring characteristics is formed by combining the disk spring 70a (70b, 70c) with the coil spring 71. However, it is needless to say that the above-mentioned operations and effects can be obtained through imparting the nonlinear spring characteristics only to the coil spring 71.

Note that, the embodiments of the present invention have described the example in which an oil is used as a working fluid, but the present invention is not limited thereto. As a matter of course, a liquid fluid such as water, and a gaseous fluid such as the air or gas may be used.

Further, the above-mentioned embodiments have described the structure in which one damping force adjusting valve is provided between the upper cylinder chamber and the reservoir, but the present invention is not limited thereto. Through providing a damping force adjusting valve also between the lower cylinder chamber and the reservoir, an extension-stroke damping force and a compression-stroke damping force can be controlled independently of each other. In this case, it is desired that relief valves be provided to a piston section for both the extension and compression strokes. Further, a damping force adjusting valve may be provided to the piston section.

Still further, the above-mentioned embodiments have described the example in which the disk valves 32 provided with the annular sealing member 96 are used as a main valve of a pilot type, but the present invention is not limited thereto. The main valve of a pilot type may be formed of an annular disk, which lifts vertically and does not bend substantially, and of a coil spring, which urges the annular disk in a valve closing direction. Further, through enlarging the radial hydraulic fluid passage 101, the pilot chamber 97 and the axial hydraulic fluid passage 58 may be formed into one hydraulic fluid chamber.

The above-mentioned embodiments have described the example in which the damping force control type hydraulic shock absorber 1 is provided to each of four wheels of a four-wheeled vehicle and the present invention is applied thereto. However, for example, the present invention may be applied only to two rear wheels or two front wheels. Further, the present invention may be applied to a two-wheeled vehicle, a three-wheeled vehicle, and a four-or-more-wheeled vehicle.

1. A suspension apparatus, comprising:
a damping force control type shock absorber provided between a vehicle body and an axle of a vehicle, the damping force control type shock absorber comprising a damping force adjusting valve;
a detecting device provided to the vehicle, for outputting a signal related to a motion condition of the vehicle; and
a control device for outputting a control current corresponding to a damping force target value to the damping force adjusting valve based on the signal,
wherein the damping force adjusting valve comprises:
a main valve for generating a damping force;
a pilot chamber for applying a pilot pressure in a direction of closing the main valve;
an inlet passage for introducing the pilot pressure into the pilot chamber;
a release passage for releasing the pilot pressure in the pilot chamber; and
a pressure control valve provided in the release passage,
wherein the pressure control valve comprises:
a valve seat provided in the release passage;
a valve body which sits on and moves away from the valve seat;
an actuator for generating a load for pressing the valve body onto the valve seat in accordance with a current; and
a spring device which acts in a direction of separating the valve body from the valve seat, and
wherein when the control device generates a minimum damping force during normal running, the control device outputs a minimum control current having a magnitude to always separate the valve body from the valve seat.

2. A suspension apparatus according to claim 1,
wherein the control device comprises current cut-off control in which no current is output, besides control performed during the normal running, and
wherein the damping force adjusting valve generates a damping force higher than the minimum damping force when the valve body is most separated from the valve seat.

3. A suspension apparatus according to claim 1, wherein the spring device has a larger spring constant when the valve body is at a position close to the valve seat than a spring constant when the valve body is away from the position close to the valve seat.

4. suspension apparatus according to claim 3, wherein the spring device comprises:
a coil spring always acting on the valve body; and
a disk spring acting only when the valve body is at the position close to the valve seat.

5. A suspension apparatus according to claim 4, wherein the minimum control current corresponds to a control current which is supplied to cause the disk spring to act.

6. A suspension apparatus according to claim 1,
wherein the damping force control type shock absorber further comprises:
a cylinder sealingly containing a hydraulic fluid therein;
a piston slidably fitted within the cylinder;
a piston rod having one end coupled to the piston and another end extending outward from one end of the cylinder; and
a reservoir connected to the cylinder, and
wherein the main valve is provided between the reservoir and a chamber formed in the cylinder on the one end side of the cylinder.
